(19) United States
(12) Patent Application Publication
(10) Pub. No.: US 2010/0209726 A1
(43) Pub. Date: Aug. 19, 2010

(54) BIODEGRADABLE MATERIAL AND METHODS RELATED THERETO

(76) Inventors: Kelly Coover, Galesburg, KS (US); Don Coover, Galesburg, KS (US)

Correspondence Address: Clise, Billion & Cyr, P.A., 605 U.S. Highway 169, Suite 300, Plymouth, MN, 55441, US

(21) Appl. No.: 12/682,296

(22) PCT Filed: Oct. 24, 2008
(86) PCT No.: PCT/US08/81089

§ 371 Date: Apr. 9, 2010

Related U.S. Application Data
(60) Provisional application No. 60/982,929, filed on Oct. 26, 2007.
(60) Provisional application No. 60/983,987, filed on Oct. 31, 2007.

(51) Int. Cl. C08L 29/04; B32B 21/04; B32B 19/00

(52) U.S. Cl. 428/537.1; 524/557; 524/13; 428/702

(57) ABSTRACT

Embodiments of the invention relate to a method for making a biodegradable material. The method includes contacting one or more water-soluble polymers and one or more filler materials sufficient to form a mixture, utilizing an amount of water in contact with the mixture and injection molding the mixture, sufficient to form a biodegradable material.

### PRIORITY OF INVENTION

This application claims the benefit of priority to U.S. Provisional Patent Application Ser. No. 60/982,929, filed Oct. 26, 2007, and U.S. Provisional Patent Application Ser. No. 60/983,987, filed Oct. 31, 2007, which are herein incorporated by reference.

### BACKGROUND

There is currently much demand for commercial and consumer products manufactured of biodegradable materials to reduce the amount of plastics deposited in landfills or elsewhere in the environment. Many biodegradable materials are now utilizing agricultural-based components in an effort to increase biodegradability and to reduce cost (such as by using inexpensive by-products from agricultural processes). By integrating agricultural (or other natural or biodegradable) components, manufacturing challenges are increased as the introduction of such components may negatively affect the end product characteristics, increase the number or complexity of steps in the manufacturing process or increase the overall cost of processing.

Polyvinyl alcohol (PVA) is not typically utilized in injection molded processes due to its relatively high cost and complexities in processing. If injection molded, PVA is melted in a dry form and processed using a significant amount of time and energy due to the heat needed for melting. When using agricultural wastes or biological materials to fill conventional plastics, the materials are usually dried to a very low moisture content. Processing such materials at higher water content builds up steam and often causes blow out of the materials. In addition, most plastic compositions that utilize a filler material are limited to about 40% filler without significantly sacrificing final product quality.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a block flow diagram of a method of making a biodegradable material, according to some embodiments.

FIG. 2 illustrates a block flow diagram of a method of making a biodegradable material including an extrusion step, according to some embodiments.

FIG. 3 illustrates a block flow diagram of a method of making a biodegradable material including a water contacting step, according to some embodiments.

FIG. 4 illustrates a cross-sectional view of an injection molding apparatus, according to some embodiments.

FIG. 5 illustrates a block flow diagram of a method of making a biodegradable material utilizing compression molding, according to some embodiments.

### SUMMARY

Embodiments of the invention relate to a method for making a biodegradable material. The method includes contacting one or more water-soluble polymers and one or more filler materials sufficient to form a mixture, utilizing an amount of water in contact with the mixture and injection molding the mixture, sufficient to form a biodegradable material.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to a biodegradable material and methods for making biodegradable material. A water-soluble polymer, such as polyvinyl alcohol (PVA), can be injection molded or compression molded with agricultural or other biodegradable fillers in a way that produces complex geometry articles with properties, such as water resistance and strength, comparable to non-biodegradable articles. The process may also produce biodegradable material to be used in further processing or in agricultural applications. The polymer is mixed and/or processed in the presence of water and is at least partially emulsified in the water. The polymer does not undergo any significant phase change (i.e., melting) and therefore does not require the heat and energy needed to melt the polymer. The biodegradable material can be produced with a higher percentage of biodegradable or inorganic fillers than previously shown.

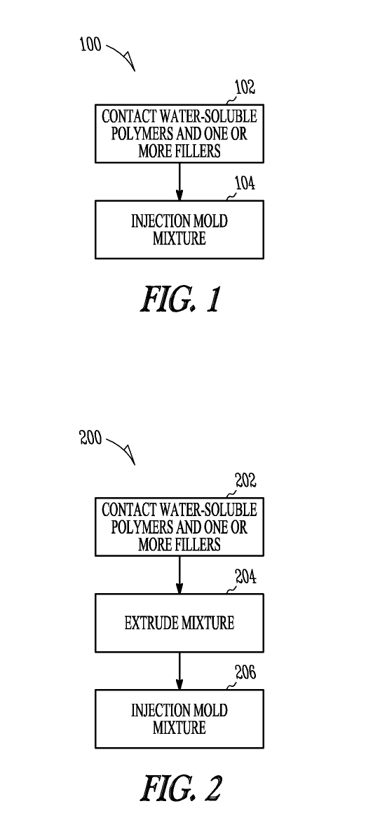

Referring to FIG. 1, a block flow diagram 100 of a method of making a biodegradable material, according to some embodiments. One or more water-soluble polymers and one or more fillers may be contacted 102 to form a mixture. The mixture may then be injection molded 104 to form a biodegradable material. In addition to the fillers, the polymer may be contacted with one or more support materials. Water is utilized in contact with the mixture and acts as a plasticizer for the mixture. Utilizing may include contacting, adding, mixing or using inherent moisture content, for example.

Contacting 102 the one or more polymers and one or more fillers may include mixing. The contacting 102 may be accomplished in the presence of water. The polymer and one or more fillers may be contacted 102 in a mixer, for example. The one or more fillers may comprise some water, such as about 2% to about 35% water, about 5% to about 25% water or about 10% to about 20% water. Whether water is added during mixing or is present in the one or more fillers, the water content of the mixture may be about 10% to about 60% by weight. The water content may also be about 20% to about 50% or about 25% to about 40% by weight of the total mixture.

The water-soluble polymer may be polyvinyl alcohol (PVA), for example. The PVA may be fully hydrolyzed and water soluble at temperatures above about 190° F. The PVA may include fine particles. One or more polymers may be contacted, such as PVA and polyethylene (PE) and/or polypropylene (PP). The polymer may be co-injected with other polymers or with other mixtures of the same polymer. For example, a PVA and filler mixture may be co-injected with other polymers or co-injected with dry PVA to yield a different finish on an article, while still maintaining biodegradability.

Another example of co-injection would be positioning a molten plug of a desired coating material in front of the mixture in the injection molding apparatus. During the injection cycle, the coating material may flow onto the tooling or mold and solidifies a thin coating. The mixture then pushes the remaining coating material forward into the mold, such that the final article will be substantially or fully coated. Examples of a coating material may include polypropylene, high density polyethylene (HDPE), low density polyethylene (LDPE) or combinations thereof. A PVA mixture may also be used as the coating material. The coating thickness may be about 0.002 to about 0.020 inches thick, about 0.005 to about 0.015 inches thick or about 0.010 to about 0.014 inches thick, for example. A double barreled injection molding apparatus may be utilized for such an embodiment.

The one or more fillers may include organic or inorganic fillers. The fillers may be cellulosic fillers. Examples of fillers include sawdust, lawn clippings, straw, hay, grass, waster paper, woodchips, switch grass or combinations thereof. Inorganic fillers, such as limestone, calcium carbonate, clays, chalk, marble, shale, talc or gypsum may be used in combination with the biodegradable water-soluble polymer. The inorganic fillers may also be utilized without the addition of organic or biodegradable fillers. A polymer and inorganic filler mixture may be formed, such that as the polymer biodegrades or is actively removed, the inorganic filler retains a desired shape (final product or article) or leaves a desired residual.

The one or more support materials may include materials utilized in the mixture for reasons or functions other than biodegradability. One or more support materials may include crushed limestone, water soluble colorants, clays, borax, chalk dust, colored particles or combinations thereof. Support materials may be utilized to strengthen the article, adjust pH, provide color, texture or otherwise alter the physical or chemical properties of the end product. Clays or borax may be utilized in cross-linking the water-soluble polymer to strengthen the article. Sodium bicarbonate may be utilized as a support material to introduce foaming and adjust the density of the biodegradable material or final article of manufacture. Sodium carbonate (soda ash) or an aldehyde, such as formaldehyde or glucoaldehyde, may also be introduced to affect the cross-linking of the polymer and customize the physical properties of the materiale (such as increased strength). These agents would also act as cross-linking agents.

Oak sawdust may be utilized as a filler material. When sawdust is utilized, crushed limestone may be added as support material to adjust the pH of the mixture or neutralize the acid in the sawdust, for example The limestone may also facilitate flow of the mixture during the injection molding phase.

The biodegradable material may include about 5% to about 40%, about 10% to about 35%, about 15% to about 30% or about 20% to about 25% of a water-soluble polymer, such as PVA (all percentages are by weight). The final water content may be about 10% to about 60%, about 20% to about 50% or about 30% to about 40%, for example The filler content may be about 5% to about 90% of the mixture or biodegradable material, about 15% to about 70% or about 25% to about 55%, for example The support materials may include a content of about 5% to about 80%, about 15% to about 65% or about 25% to about 45%. An example mixture ratio or final composition may be about 5% to about 40% PVA, about 5% to about 70% sawdust, about 5% to about 80% crushed limestone, about 0% to about 35% colorant and about 15% to about 60% water, for example.

The biodegradable material produced may be substantially or fully biodegradable. The article may be partially or fully water resistant at temperatures below about 200° F., at temperatures below about 195° F. or at temperatures below about 190° F., for example The material may be water resistant at typical environmental temperatures (such as room temperature). Articles formed from the biodegradable material may be made into complex geometries. Examples of such articles include flower pots, pipe plugs, simulated fillings for military items, coat hangers, horticultural items, picnic cutlery, plates, cups, bag pallets and packaging peanuts, to name a few.

The processing temperature of the mixture may be above the temperature at which the water-soluble polymer is soluble in water. For PVA (depending on the grade), such temperature may be around 190° F. or above. At processing temperatures above 212° F., a shut-off valve may utilized near the tip of the injection molding apparatus to prevent material leakage due to pressure buildup from steam generated within the apparatus. The temperature of processing may be up to about 400° F., for example, to speed the heating of the mixture. Because the polymer is at least partially emulsified, it can be heated above the melt temperature for faster and more efficient processing. A processing temperature of about 200° F. to about 230° F. may be utilized. Processing temperatures of about 190° F. to about 400° F., about 210° F. to about 300° F., about 215° F. to about 250° F. or about 220° F. to about 230° F. may be utilized. Temperatures higher than about 400° F. may also be used.

Because no phase change or heat of fusion is needed to melt the polymer and water is utilized as a plasticizer, much less energy is consumed when compared to conventional processing. The injection pressure of the mixture may be about 1000 to about 3000 PSI, about 2000 to about 5000 PSI or about 4000 to about 10000 PSI, which flows the non-Newtonian fluid at a desired moisture content without melting. When the pressure is released, the mixture re-solidifies.

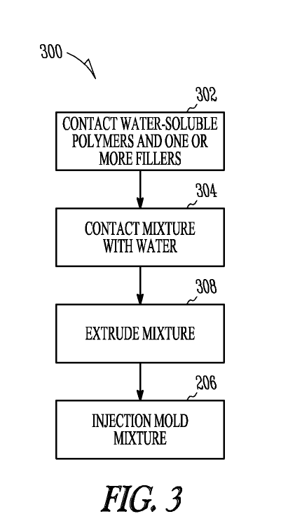

Referring to FIG. 2, a block flow diagram 200 of a method of making a biodegradable material including an extrusion step, according to some embodiments. One or more water-soluble polymers and one or more fillers may be contacted 202 to form a mixture. The mixture may be extruded 204. The mixture may then be injection molded 206 to form a biodegradable material.

The mixture may be extruded 204 in order to reduce the particle size and coat many of the particles in order to reduce their friction angle. Although the mixture may be injection molded without an extrusion 204 step, the high angle of friction of the material may be reduced by extrusion 204. Extrusion 204 may be accomplished separately from injection molding 206 or in-line with injection molding 206, such as by using the plunger of the injection molding apparatus to extrude 204 the mixture. The mixture may be ground or reduced in size during or after extrusion 204. The size of the particles may be dependent on the material or final product to be manufactured. The particles of the mixture may need to include particles with the largest particle size smaller than the smallest cross section of the particle mixture. The particles may be well graded, with varying sizes of particles, for example. The mixture may have a total water content of about 10% to about 60%, about 20% to about 45% or about 25% to about 30% during extrusion 204, for example.

Water may be utilized as a plasticizer during extrusion 204, during injection molding 206 or both. Depending on the water content utilized, the biodegradable material or final product may have some small amount of shrinkage occur upon drying. If the geometry of the article is of a relatively low complexity, less water may be utilized.

Referring to FIG. 3, a block flow diagram 300 of a method of making a biodegradable material including a water contacting step is shown, according to some embodiments. One or more water-soluble polymers and one or more fillers may be contacted 302 to form a mixture. The mixture may be contacted 304 with water. The mixture may then be extruded 306. The mixture may be injection molded 308 to form a biodegradable material.

Contacting 304 with water may occur at various stages in the process. Water may be introduced or utilized as moisture content in the one or more fillers or one or more support materials. Water may be contacted 304 with the mixture during extrusion 306, such as a total water content of about 10% to about 60%, about 20% to about 45% or about 25% to about 30%. Water may also be contacted 304 with the mixture after the initial contacting 302 stage, but before extrusion 306. Water may be introduced or contacted 304 during injection molding 308, especially if an extrusion 306 step is not utilized. The water content of the mixture may be about 10% to about 60%, about 20% to about 45% or about 25% to about 30% at any given point in the process during or after mixing, for example. Water may be contacted 304 during one or more of these stages.

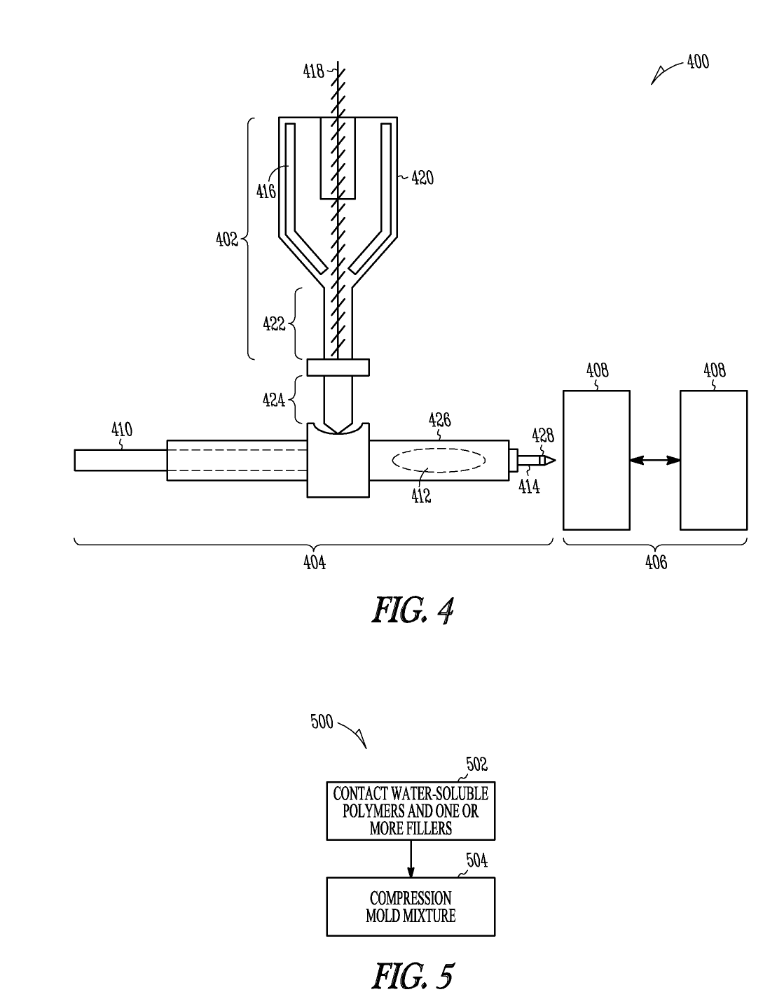

Referring to FIG. 4, a cross-sectional view 400 of an injection molding apparatus is shown, according to some embodiments. An extruder 402 may be coupled to an injection molding apparatus 404. The extruder 402 includes the material hopper 420, screw 418, one or more optional scraping arms 416, extruder barrel 422 and extruder tip 424. The injection molding apparatus 404 includes a plunger 410, optional material diverter 412, plunger barrel 426, optional shut-off valve 428 and injector tip 414. A mold 406 may include mold components 408 and be positioned near or in contact with the injector tip 414.

Referring to FIG. 5, a block flow diagram 500 of a method of making a biodegradable material utilizing compression molding, according to some embodiments. One or more water-soluble polymers may be contacted 502 with one or more fillers, sufficient to form a mixture. The mixture may be compression molded 504. Alternatively to injection molding, the mixture may be compression molded. Compression molding may be accomplished after contacting or after an optional extrusion step.

1. A method for making a biodegradable material, comprising:
contacting one or more water-soluble polymers and one or more filler materials, sufficient to form a mixture;
utilizing an amount of water in contact with the mixture; and
injection molding the mixture, sufficient to form a biodegradable material.

2. The method of claim 1, wherein the one or more water-soluble polymers comprise polyvinyl alcohol (PVA).

3. The method of claim 1, wherein utilizing comprises contacting the mixture with water.

4. The method of claim 1, wherein utilizing comprises utilizing an amount of water in contact with the one or more filler materials prior to contacting with the one or more water-soluble polymers.

5. The method of claim 1, wherein contacting comprises mixing.

6. The method of claim 1, further comprising one or more additional polymers contacting the one or more fillers.

7. The method of claim 1, further comprising after contacting, extruding the mixture.

8. The method of claim 7, wherein utilizing comprises contacting the mixture with water during extruding.

9. The method of claim 7, wherein utilizing comprises contacting the mixture with water after extruding.

10. The method of claim 1, wherein the one or more water-soluble polymers are partially or fully emulsified with the water in the mixture.

11. The method of claim 1, wherein the one or more water-soluble polymers do not undergo a phase change.

12. The method of claim 1, wherein the one or more fillers comprise organic or inorganic fillers.

13. The method of claim 1, wherein the one or more fillers comprise cellulosic fillers.

14. The method of claim 1, wherein the one or more fillers comprise sawdust, lawn clippings, straw, hay, grass, waster paper, woodchips, switch grass or combinations thereof.

15. The method of claim 1, further comprising contacting one or more support materials with the one or more water-soluble polymers and one or more filler materials.

16. The method of claim 15, wherein the one or more support materials comprise crushed limestone.

17. The method of claim 1, wherein the one or more fillers comprise water soluble colorants, clays, borax, crushed limestone, chalk dust, colored particles or combinations thereof.

18. The method of claim 1, wherein one or more of the fillers or one or more support materials comprises a cross-linking agent.

19. The method of claim 18, wherein the cross-linking agent comprises borax, an aldehyde or a combination thereof.

20. The method of claim 1, wherein injection molding includes co-injecting one or more polymers with the mixture.

21. The method claim 20, wherein the one or more polymers comprise polyethylene, polypropylene, polyvinyl alcohol or a combination thereof.

22. A method for making a biodegradable material, comprising:
contacting one or more water-soluble polymers and one or more filler materials, sufficient to form a mixture;
utilizing an amount of water in contact with the mixture;
extruding the mixture; and
injection molding the mixture, sufficient to form a biodegradable material.

23. A method for making a biodegradable material, comprising:
contacting one or more water-soluble polymers and one or more filler materials, sufficient to form a mixture;
utilizing an amount of water in contact with the mixture; and
compression molding the mixture, sufficient to form a biodegradable material.

24. A biodegradable material, comprising:
about 5% to about 40% by weight of one or more water-soluble polymers;
about 10% to about 60% by weight water; and
about 5% to about 90% by weight of one or more biodegradable fillers.

25. The material of claim 24, further comprising one or more support materials.

26. The material of claim 25, wherein the one or more support materials comprise about 5% to about 80% of the material by weight.

27. The material of claim 24, wherein the one or more polymers comprise PVA.

28. The material of claim 24, wherein the one or more fillers comprise sawdust.

29. The material of claim 25, wherein the one or more support materials comprise crushed limestone.

30. The material of claim 24, further comprising additional polymers.
